(19) United States
(12) Patent Application Publication
(10) Pub. No.: US 2010/0091489 A1
(43) Pub. Date: Apr. 15, 2010

(54) Seat Light and Plaque Holder

(76) Inventors: Dennis Pearson, Foothill Ranch, CA (US); Terry Horwitz, Garden Grove, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/546,562

(22) Filed: Aug. 24, 2009

Related U.S. Application Data
(60) Provisional application No. 61/104,528, filed on Oct. 10, 2008.

(51) Int. Cl. F21V 1/00; G09F 3/18

(52) U.S. Cl. 362/235; 40/642.02

(57) ABSTRACT

A seat light comprising a lamp shade component having a vertical back edge and an arcuate hood and a rectangular shroud component mountable within the lamp shade and encasing a circuit board carrying a plurality of LED's wherein the positioning of the LED's and shape of the hood cooperate to direct light down toward an adjacent aisleway, while concealing the shroud and LED's from normal view. A cooperating plaque holder adapted to be illuminated by the seat light is also disclosed.

### CROSS-REFERENCE TO RELATED APPLICATIONS

This application claims the benefit of and priority to U.S. Provisional Application Ser. No. 61/104,528, filed Oct. 10, 2008, entitled, “SEAT LIGHT AND PLAQUE HOLDER,” the contents of which are incorporated by reference herein in its entirety.

### BACKGROUND

1. Field

The subject disclosure relates to lighting and lighting fixtures and more particularly to a self-contained LED light fixture particularly useful in a seat-mounted aisle lighting configuration.

2. Related Art

In the past, aisle lighting has been used in theatres and other venues for assisting patrons in ascending and descending aisles, stairways, and the like.

### SUMMARY

The following is a summary of various aspects and advantages realizable according to various embodiments of the invention. It is provided as an introduction to assist those skilled in the art to more rapidly assimilate the detailed discussion which ensues and does not and is not intended in any way to limit the scope of the claims which are appended hereto in order to particularly point out the invention.

A seat light according to an illustrative embodiment comprises a lamp shade component having a vertical back edge and an arcuate hood. A rectangular shroud component having an opening in a front surface thereof is mountable within the lamp shade and encases a circuit board carrying a plurality of LEDs and positioned within the shroud such that the LEDs lie in the opening in the shroud. The positioning of the LEDs and shape of the hood cooperate to direct light down toward an adjacent aisleway, while concealing the shroud and LEDs from normal view.

In one embodiment, the lamp shade component has a first interior planar surface projecting outwardly away from a vertical back edge of the shade and meeting along a common edge with a second interior planar surface projecting back inwardly toward the vertical back edge. In this embodiment, the second planar surface may further include respective mounting blocks at opposite ends thereof for positioning the LED-carrying shroud laterally within the hood, while the arced hood includes a horizontal lip formed on an inner surface thereof for supporting an inside edge of the shroud.

Various embodiments may further include a plaque holder adapted to integrally mount with the seat light such that a row indicator or other designation carried by the plaque may be illuminated by the seat light.

### DRAWINGS

The features of the present disclosure will become more apparent with reference to the following description taken in conjunction with the accompanying drawings wherein like reference numerals denote like elements and in which:

FIG. 1 is a front perspective view of a seat light and cooperating plaque holder according to an illustrative embodiment;

FIG. 2 is an exploded perspective illustrating the components of the embodiment of FIG. 1;

FIG. 3 is a sectional view of a light shade and installed shroud component taken at 3-3 of FIG. 2 according to an illustrative embodiment;

FIG. 4 is a rear view of the shroud and circuit board of FIG. 3;

FIG. 5 is a front view of a light shade component of the illustrative embodiment;

FIG. 6 is a front view of a shroud component of an illustrative embodiment;

FIG. 7 is a side view of the shroud component of FIG. 6;

FIG. 8 is a sectional view of the shroud component taken at 8-8 of FIG. 6;

FIG. 9 is a back view of the shroud component of FIG. 6;

FIG. 10 is a rear perspective view of the shroud component of FIG. 6;

FIG. 11 is a perspective view of a plaque holder according to an illustrative embodiment;

FIG. 12 is a front view of the plaque holder FIG. 11;

FIG. 13 is a side view of the plaque holder FIG. 11;

FIG. 14 is a sectional view of the plaque holder of FIG. 11 taken at 14-14 of FIG. 12;

FIG. 15 is a sectional view of the plaque holder of FIG. 11 taken at 15-15 of FIG. 12;

FIG. 16 is a top view of a LED circuit board according to an illustrative embodiment;

FIG. 17 is a side view of the LED circuit board of FIG. 16; and

FIGS. 18 and 19 illustrate application of an illustrative embodiment to a seat.

### DETAILED DESCRIPTION

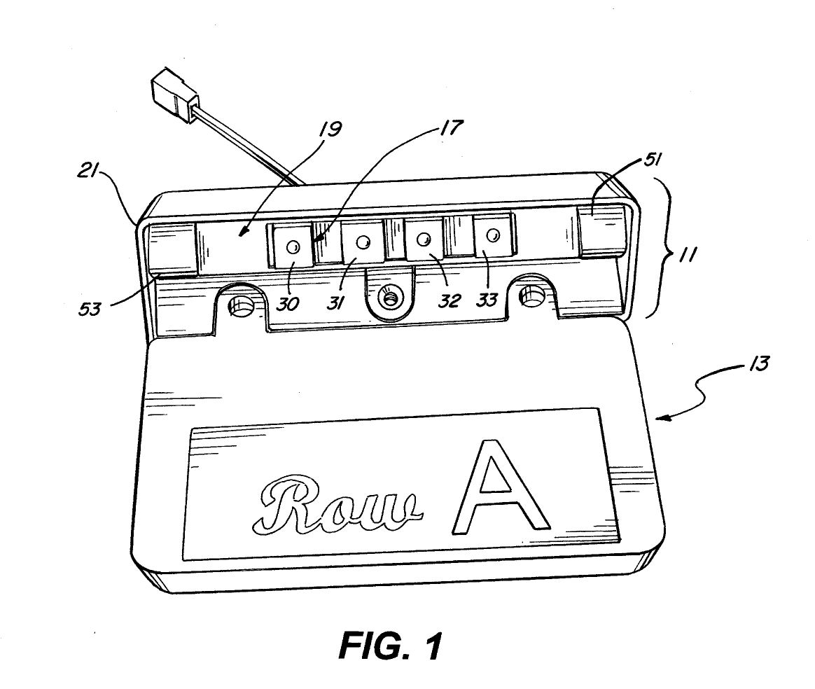

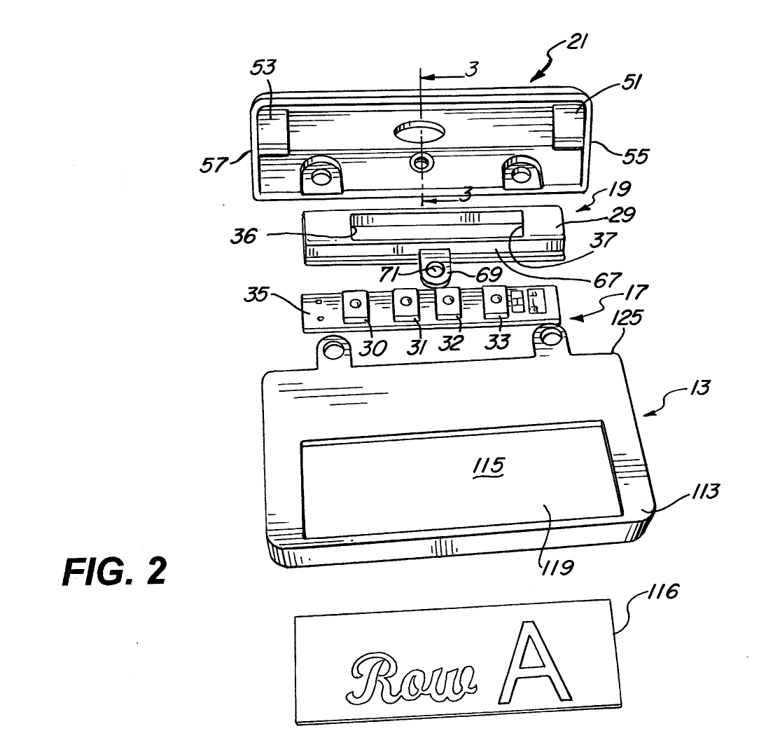

An illustrative seat light 11 and optional cooperating plaque holder 13 are shown in FIGS. 1-2. The seat light 11 includes three components: an LED board 17; a board shroud 19, which encases the board 17; and a light shade 21, which receives and mounts the board shroud 19 and its encased LED board 17. The light shade 21 is further designed to direct illumination from the LEDs 30, 31, 32, 33 onto the plaque and a seat, as well as an adjacent aisleway, while at the same time concealing the shroud 19, and the LEDs 30, 31, 32, 33 from normal view.

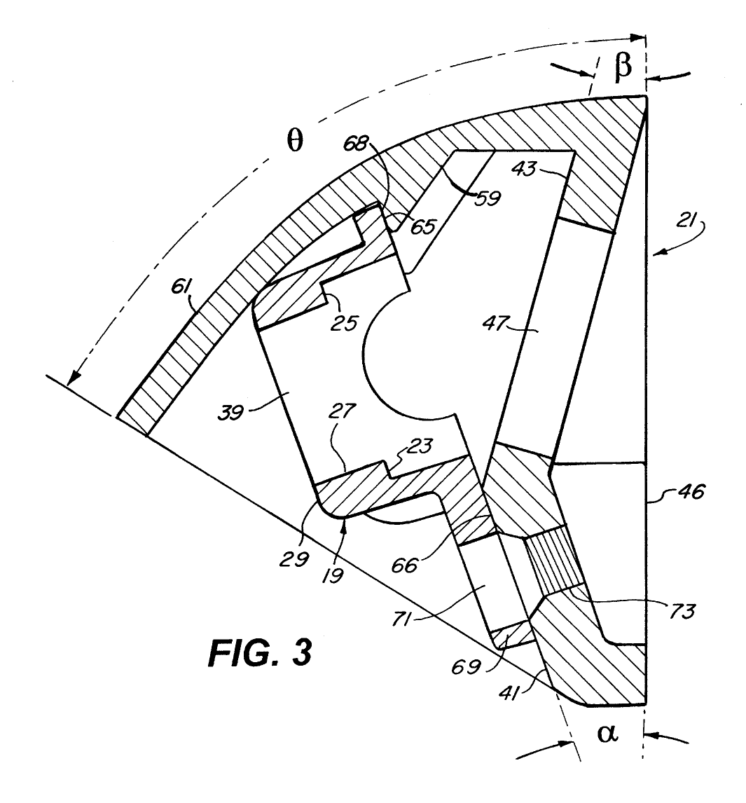

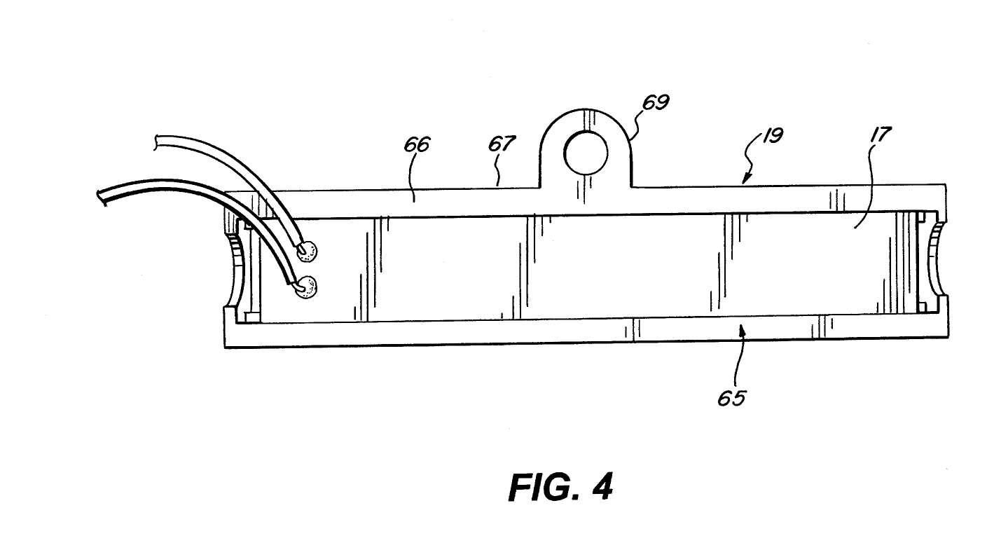

The front surface 35 of the LED board 17 shown, e.g., in FIG. 2, fits flush against parallel horizontal rims 23, 25 located on the interior surface 27 of the board shroud 19. These rims 23, 25 are shown in FIGS. 3 and 9. The parallel rims 23, 25 position the circuit board 17 such that the LEDs 30-33 lie flush with the front surface 29 of the shroud 19. The end most LEDs 30, 33 are positioned on the board 17 such that they abut the respective vertical edges 36, 37 of the rectangular opening 39 in the front surface of the shroud 19. This abutment positions the board 17 and prevents lateral sliding of the board 17 with respect to the inner parallel rims 23, 25. The number of LEDs may be varied, e.g., from two to four in illustrative embodiments.

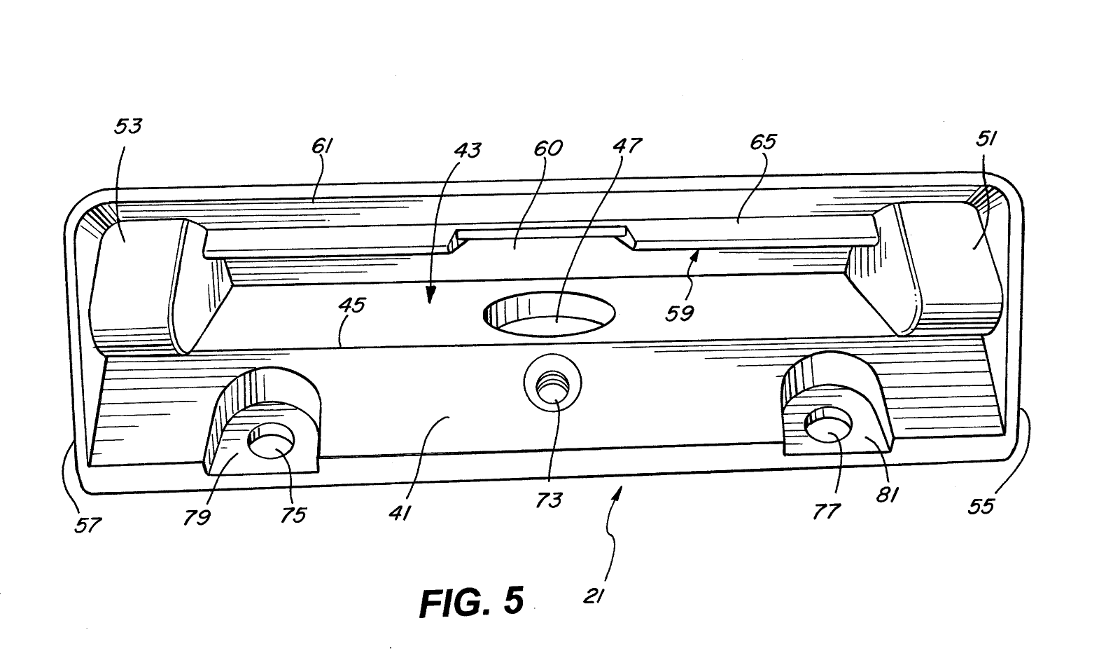

The light shade 21 includes vertical back edges 46, 47 and two interior generally planar surfaces 41, 43, shown, for example, in FIGS. 3 and 5. The planar surfaces 41, 43 intersect along a common edge 45. In an illustrative embodiment, the lower surface 41 makes an acute angle α with the vertical back edge 46 of the light shade of 20 degrees, while the upper surface 43 makes an angle β with the vertical back edge 46 of 16 degrees.

As shown in FIG. 5, the upper planar surface 43 of the light shade 21 includes a central opening 47 for passing an electrical power cable to the LED board 17 and includes respective spacer blocks 51, 53 at its respective ends 55, 57. The spacer blocks 51, 53 at the respective ends 55, 57 of the light shade 21 center the shroud 19 within the shade 21. In other embodiments, the power cable opening 47 may be located at either end of the light shade 21, as opposed to the center.

A horizontal lip 59 formed (e.g. molded) along the interior 60 of the arced hood portion 61 of the shroud 19 appropriately positions the shroud 19 and encased circuit board 17. Specifically, as shown in FIG. 3, the upper back edge 65 of the shroud 19 rests on the front surface 68 of the lip 59, while the lower back edge 66 of the shroud 19 rests on the lower planar surface 41 of the light shade 21.

In the illustrative embodiment, the plane of the board 17 is positioned at the angle α of 20 degrees to the vertical such that the light from the LEDs 30, 31, 32, 33 is directed out and slightly downwardly. The hood portion 61 of the light shade 21 is preferably arced through an angle θ sufficient to shield the LED bank from the view of persons walking up or down an aisleway, while still directing sufficient light to properly illuminate it. In one embodiment, the angle θ may be, for example, 58 degrees.

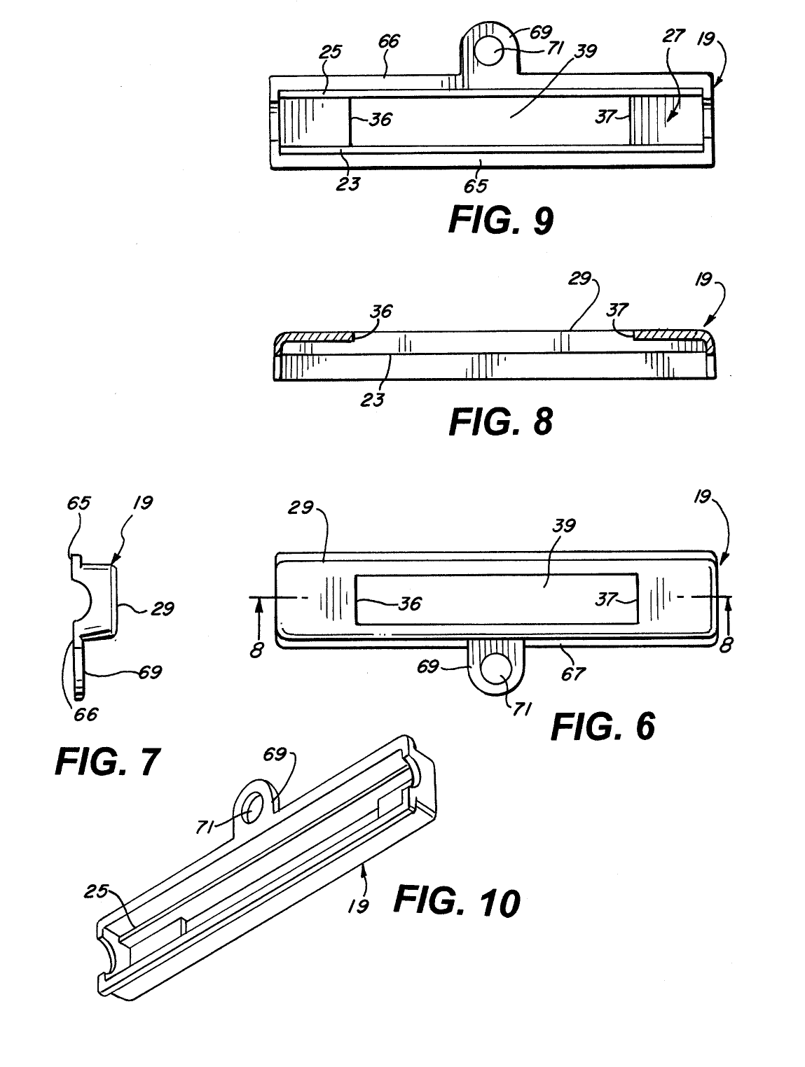

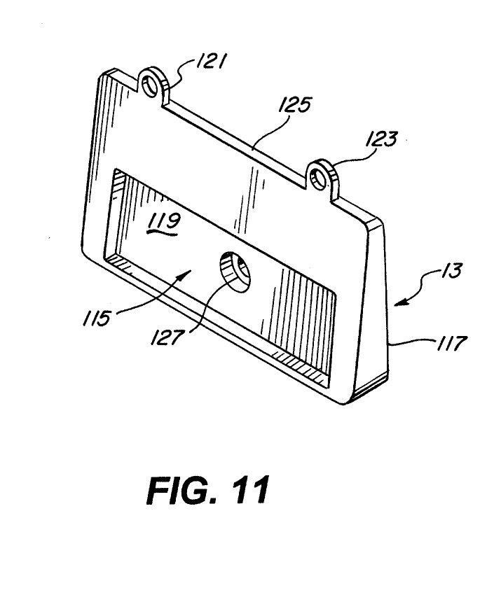

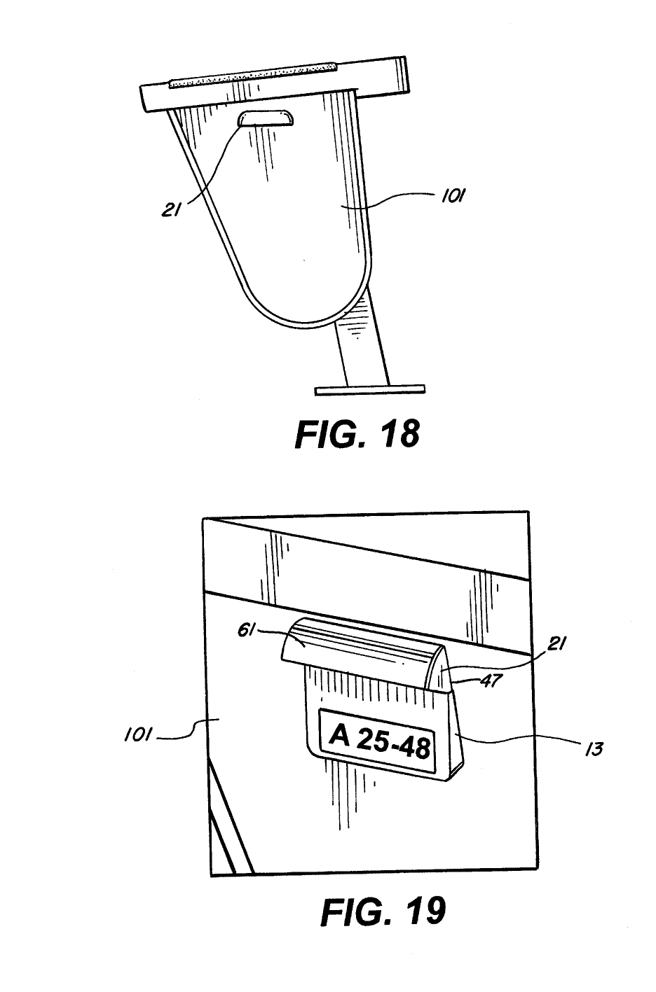

As illustrated in FIGS. 2 and 6-10, the lower edge 67 of the shroud 19 has a tab 69 formed thereon, which has a mounting hole 71 positioned to concentrically align with another mounting hole 73 formed in the lower planar surface 41 of the shade 21. Thus, a single fastening device can be used to attach the shroud 19 to the shade 21 and then to a surface behind the shade 21, such as, for example, the side of a theatre seat 101 disposed along an aisleway, as illustrated in FIGS. 18 and 19. As shown in FIG. 5, the lower surface of the light shade 21 further has two additional mounting holes 75, 77 with surrounding depressions 79, 81 shaped to receive respective tabs 121, 123 of the plaque holder 111, as well as suitable fastening devices, such as, for example, screws.

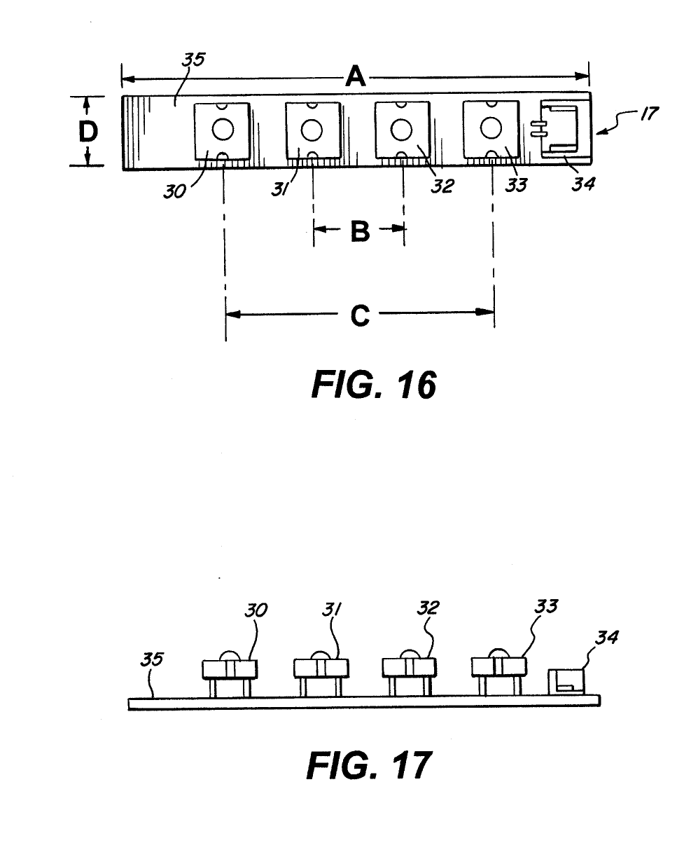

The LED board 17 is illustrated in further details in FIGS. 16 and 17. The board 17 includes the four LED's 30, 31, 32, 33 and a socket 34 for electrical power connection. Illustrative dimensions of one embodiment of a board 17 are A=2.625 inches, B=0.500 inches, C=1.500 inches and D=0.375 inches.

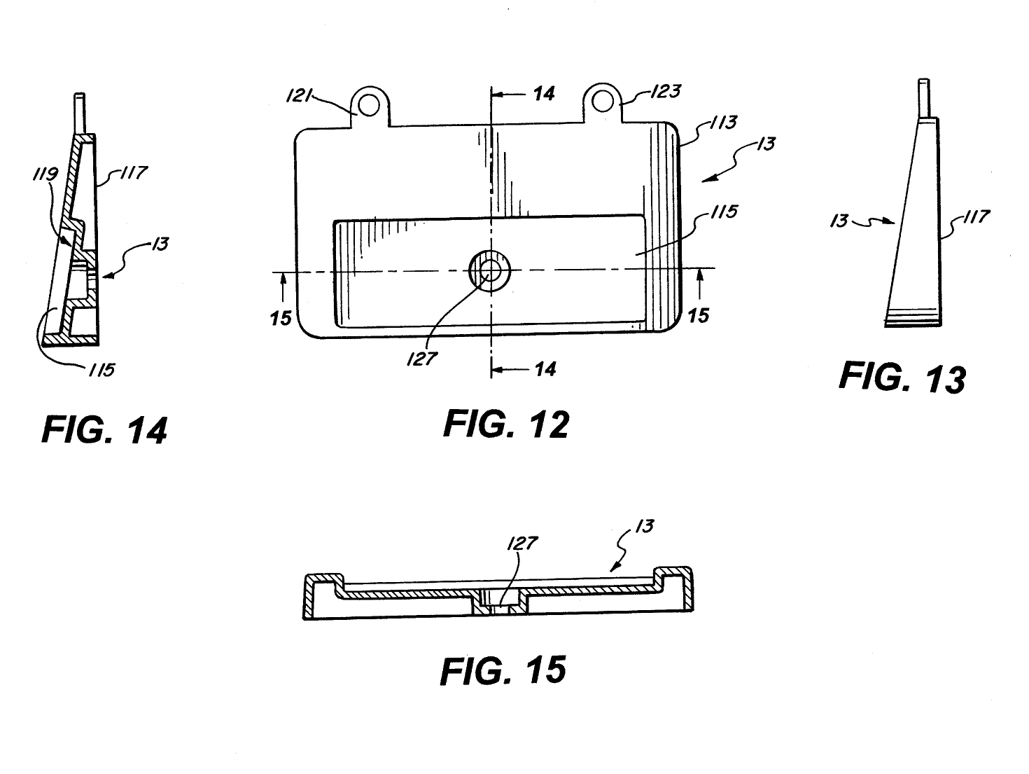

As shown in FIGS. 12-15, the plaque holder 13 includes a generally rectangular frame 113, which contains a rectangular well 115 for receiving and holding a rectangular plaque, such as, for example, a planar row or aisle indicator 116 (FIG. 2). The back surface 119 of the well or receptacle 115 lies at an angle θ of, for example, 10 degrees with respect to the vertical back edge 117 of the holder 13 to enhance the pick-up and reflection of light from the seat light 13 and hence enhance the visibility of the row indicator 116.

As noted above, the plaque holder 13 further includes first and second mounting tabs 121, 123 with circular openings along its top edge 125 and a countersunk cylindrical opening 127 centrally positioned in the rectangular plaque receptacle 115. The plaque, e.g. 116, may be provided with double sided-tape on its back surface to attach it to the plaque receptacle 115.

The plaque holder 13 and light shade 21 may be fabricated of diecast aluminum, for example, A380.0-F die casting alloy. Other suitable metals, plastics, or composites could of course be used in various alternate embodiments. The LED shroud 19 may be fabricated of a suitable plastic, for example, such as black Bayer Macrolor polycarbonate 90-2205.

Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed:

1. A light fixture comprising:
a lamp shade having a vertical back edge and an arcuate hood;
a rectangular shroud component having an opening in a front surface thereof and mountable within said lamp shade beneath said hood; and
a circuit board carrying a plurality of light emitting diodes (LEDs) and mounted within said shroud component, said LEDs being positioned on said circuit board to direct illumination through said opening.

2. The light fixture of claim 1 wherein said lamp shade has a first interior planar surface projecting outwardly with respect to a vertical back edge of said shade component, said first surface meeting along an edge with a second interior planar surface projecting inwardly toward said vertical back edge.

3. The light fixture of claim 2 wherein said second planar surface has respective mounting blocks at opposite ends thereof for positioning said shroud component.

4. The light fixture of claim 3 wherein said arcuate hood has a lip formed on an inner surface thereof for supporting an edge of said shroud component.

5. The light fixture of claim I further comprising a plaque holder mountable along a lower edge of said lamp shade component.

6. The light fixture of claim 1 wherein the arcuate hood is arced through an angle sufficient to shield the LEDs from the view of persons walking up or down an aisleway, while still directing sufficient light to properly illuminate an aisleway.

7. The light fixture of claim 3 wherein the arcuate hood is arced through an angle sufficient to shield the LEDs from the view of persons walking up or down an aisleway, while still directing sufficient light to properly illuminate an aisleway.

8. A light fixture compromising:
a lamp shade component having a vertical back edge and an arcuate hood, said lamp shade component having a first interior planar surface projecting outwardly with respect to a vertical back edge of said lamp shade component, said first surface meeting along an edge with a second interior planar surface projecting inwardly toward said vertical back edge, said second planar surface having respective mounting blocks at opposite ends, said arcuate hood having a lip formed on an inner surface thereof;
a rectangular shroud component having an opening in a front surface thereof and mountable within said lamp shade beneath said hood, said shroud component being positioned between said mounting blocks and supported by said lip; and
a circuit board carrying a plurality of light emitting diodes (LED's) and mounted within said shroud component, said LED's being positioned on said circuit board to direct illumination through said opening.

9. The light fixture of claim 8 further comprising a plaque holder mountable along a lower edge of said lamp shade component.

10. The light fixture of claim 8 wherein the arcuate hood is arced through an angle sufficient to direct light down toward an adjacent pathway, while shielding the shroud and LEDs from normal view.

11. The light fixture of claim 1 wherein the arcuate hood is arced through an angle sufficient to direct light down toward an adjacent pathway, while shielding the shroud ad LEDs from normal view.

12. A light fixture comprising:
a lamp shade component having an arcuate hood, a first interior planar surface projecting outwardly with respect to the vertical, said first surface meeting along an edge with a second interior planar surface projecting inwardly toward the vertical;
a rectangular shroud component having an opening in a front surface thereof and mountable within said lamp shade component beneath said hood; and
a circuit board carrying a plurality of light emitting diodes (LEDs) and mounted within said shroud component, said LED's being positioned on said circuit board to direct illumination through said opening.

13. The light fixture of claim 12 wherein said second planar surface has respective mounting blocks at opposite ends thereof for positioning said shroud.

14. The light fixture of claim 13 wherein said arcuate hood has a lip formed on an inner surface thereof for supporting an edge of said shroud.

15. The light fixture of claim 12 further comprising a plaque holder mountable along a lower edge of said lamp shade component.

16. The light fixture of claim 12 wherein the arcuate hood is arced through an angle sufficient to shield the LED's from the view of persons walking up or down an aisleway, while still directing sufficient light to properly illuminate an aisleway.
